(19) United States
(12) Patent Application Publication
(10) Pub. No.: US 2011/0176639 A1
(43) Pub. Date: Jul. 21, 2011

(54) RADIO BASE STATION

(75) Inventor: Eiji Nakayama, Osaka (JP)

(73) Assignee: KYOCERA CORPORATION, Kyoto-shi, Kyoto (JP)

(21) Appl. No.: 13/056,567

(22) PCT Filed: Jun. 30, 2009
(86) PCT No.: PCT/JP2009/003027

§ 371 Date: Jan. 28, 2011

(30) Foreign Application Priority Data
Jul. 30, 2008 (JP) 2008-195753

(51) Int. Cl. H04L 27/06

(52) U.S. Cl. 375/317; 375/340

(57) ABSTRACT

The radio base station of the present invention detects desired sampling points, which are sampling points having reception levels higher than or equivalent to a predetermined threshold, to calculate a ratio of the desired sampling points to the entirety of sampling points contained in a desired bandwidth, the total number of sampling points being equivalent to the number of carriers in one cycle of the frequency band of the reception signal. Further, so as to calculate a gain to be applied in the amplification of signal level to a predetermined target level, the radio station uses as a gain a value obtained by dividing the target level by a product, the product being obtained by performing multiplication of an average value of levels of the signal components within the desired frequency band and an reciprocal of the ratio calculated.

### TECHNICAL FIELD

The present invention relates to a radio base station and technology applied thereto, especially a technology of gain control involving amplification of a received signal.

### BACKGROUND ART

Conventionally, in devices for receiving wireless signals such as a radio base station, a technology of performing gain adjustment with use of an amplifier has been applied for the purpose of converting a reception level of a received signal to a desired level.

In the conventional gain adjustment method, gain level is adjusted in such a manner that an average value of reception levels of a plurality of signal components lying within the band of the received signal equals a desired level after gain adjustment. However, when adopting such method, the average reception level of the signal components within the band results in having an undesirably high value in cases where interference wave components having a high reception level is contained in the received signal (refer to FIG. 5A). In such cases, amplification rate decreases and thus the reception level of the received signal components within the band is not appropriately amplified to a target level. Considering such results, the conventional gain adjustment method is deemed to be unsatisfactory (refer to FIG. 5B). Here, note that in FIGS. 5A and 5B, the shadowed areas indicate the received signal components within the desired bandwidth, whereas the black bars indicate the interference wave components picked up by the received signal.

So as to overcome such problems, Patent Literature 1 discloses a technology in which signal components of the received signal having reception levels higher than or equal to the target level are specified as interference wave components and are excluded prior to calculating the average reception level of the signal components contained in the reception band, and in which a gain is set so that the average reception level, when converted by applying the gain, equals the target level. Thus, by applying the technology Patent Literature 1 discloses, the calculation of gain, and amplification of the received signal components within a desired bandwidth to the target level can be carried out with a higher extent of accuracy compared to when the conventional technology is applied (refer to FIG. 5C).

### CITATION LIST

### [Patent Literature]

### [Patent Literature 1]

### Japanese Patent Application Publication No. 2003-219313

### SUMMARY OF INVENTION

### Technical Problem

However, irrespective to whether the gain control applied is that of the conventional technology or that disclosed in Patent Literature 1, drawbacks commonly arise in cases where desired signal components do not exist covering the entire desired bandwidth of the received signal. FIG. 6A is a conceptual diagram of a received signal in which desired signal components exist covering only a bandwidth range We within a desired bandwidth W.

When applying the gain adjustment of the conventional technology, the gain is set so that the average reception level, when converted applying the gain, meets the target level, the average reception level being obtained through dividing the sum of the reception levels (He) of signal components within the reception band by the reception bandwidth (W). If the gain level is set in such a manner when desired signal components exist covering only the range We of the total bandwidth, the reception level of the received signal components within the desired bandwidth after being multiplied by the gain exceeds the target level as depicted in FIG. 6B. This is undesirable, since if the signal is a signal exceeding the target level as described above, unnecessary noises will be generated as a result of quadrature demodulation to be performed subsequently. This problem arises because in quadrature demodulation, a range of appropriate input level is set in advance.

Similarly, applying the gain adjustment as disclosed in Patent Literature 1, if the received signal is a signal as depicted in FIG. 6A, gain is set and amplification is performed applying the gain obtained in the same manner as in the gain adjustment of the conventional technology. Thus, the reception level of the received signal components within the desired bandwidth after being multiplied by the gain exceeds the target level as depicted in FIG. 6C.

As description has been made in the above, although there is a difference in whether interference wave components are removed or not, in both methods of gain adjustment, gain is set so as to convert the average reception level of the signal components contained in the entire reception band to the desired level.

Therefore, if desired signal components do not exist covering the entire desired bandwidth, the average reception level of the signal components will result in having a low value. And further, since the gain will be consequently set at a high value, the received signal components within the desired bandwidth will be amplified to a higher level than is appropriate.

The present invention has been conceived in view of the above problems. The present invention aims to provide a radio base station which is capable of appropriately calculating and setting the gain level, even in cases where desired signal components do not exist covering the entire range of a desired bandwidth.

### Solution to Problem

In order to solve the above-presented problems, the present invention provides a radio base station for adjusting a reception level of a received signal to a desired level, the radio base station comprising: a reception unit operable to receive a signal of a desired frequency band; a first detection unit operable to calculate a ratio of a plurality of first signal components to an entirety of signal components contained in the desired frequency band of the received signal, the first signal components each having a reception level higher than or equal to a predetermined threshold; and a gain calculation unit operable to calculate a gain used to amplify the reception level of the received signal according to the ratio.

### Advantageous Effects of Invention

According to the above structure, the radio base station pertaining to the present invention calculates and sets the gain according to a ratio of the number of desired signal components to the total number of signal components contained in the desired bandwidth of the received signal. Thus, the received signal components within the desired band can be amplified to the desired level using an appropriately set gain, even in cases where the desired signal components do not exist covering the entire range of a desired bandwidth.

### BRIEF DESCRIPTION OF DRAWINGS

FIG. 1 is a block diagram showing the functional structure of a radio base station according to Embodiment 1 of the present invention.

FIG. 2A is a diagram showing a signal before gain adjustment is applied, while FIG. 2B is a diagram showing a signal having been applied gain adjustment according to Embodiment 1 of the present invention.

FIG. 3 is a block diagram showing the functional structure of the radio base station according to Embodiment 2 of the present invention.

FIG. 4A is a diagram showing a signal before gain adjustment is applied, while FIG. 4B is a diagram showing a signal having been applied gain adjustment of Patent Literature 1 and FIG. 4C is a diagram showing a signal having been applied gain adjustment according to Embodiment 2 of the present invention.

FIGS. 5A, 5B, and 5C are diagrams for explaining gain adjustment of the conventional technology. FIG. 5A is a conceptual diagram of a received signal, FIG. 5B is a conceptual diagram of a signal having been applied gain adjustment of the conventional technology, and FIG. 5C is a conceptual diagram of a signal having been applied gain adjustment of Patent Literature 1.

FIGS. 6A, 6B, and 6C are diagrams for explaining the problems of the conventional gain adjustment method. FIG. 6A is a conceptual diagram of a received signal before gain adjustment is applied, FIG. 6B is a conceptual diagram of a signal having been applied gain adjustment of the conventional technology, and FIG. 6C is a conceptual diagram of a signal having been applied gain adjustment of Patent Literature 1.

### DESCRIPTION OF EMBODIMENTS

The following describes preferred embodiments of the radio base station pertaining to the present invention, with reference to the accompanying drawings.

### Embodiment 1

<Structure>

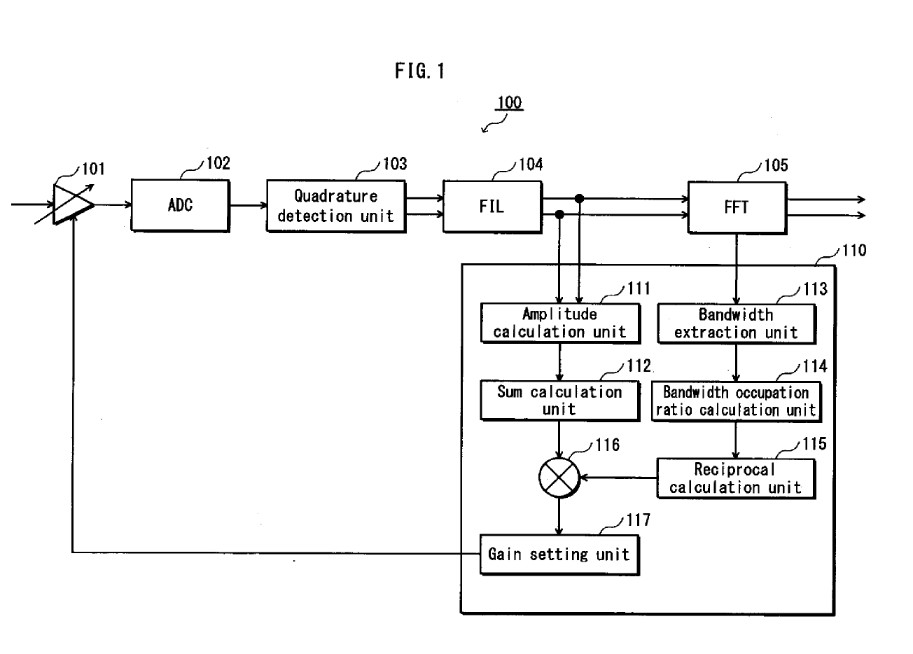

FIG. 1 is a block diagram showing the functional structure of a part of a receiver included in a radio base station 100 according to the present invention. Note that hereinafter in the present embodiment, description will be made mainly focusing on gain control being performed in the radio base station and being applied to a received signal. Description on other functions commonly provided to a radio base station, such as a wireless transmission function and upper layers of signal processing performed on the received signal, will be omitted hereinafter.

As depicted in FIG. 1, the radio base station 100 includes an amplifier 101, an ADC (Analog Digital Converter) 102, a quadrature detection unit 103, an FIL (Filter) 104, an FFT (Fast Fourier Transfer) 105, and a gain adjustment unit 110.

The amplifier 101 amplifies an input signal by applying a gain set by the gain adjustment unit 110. Here, the input signal received by the amplifier 101 is a signal obtained by performing filtering, with use of an analog filter, on a signal received via an antenna.

The ADC 102 performs digital conversion on the amplified signal output from the amplifier 101.

The quadrature detection unit 103 performs quadrature demodulation on the digital signal output from the ADC 102.

The FIL 104 removes, by digital filtering, adjacent channel signal components from the quadrature-demodulated signal. The number of data pieces after filtering is equivalent to the number of carriers in one cycle. For example, if the bandwidth is 10 MHz, the number of data pieces after filtering is 1024 (1152 including guard interval), which is equivalent to the number of sampling points in one cycle.

The FFT 105 is a transformer which performs fast fourier transform on the signal received from the FIL 104, thereby converting a time-domain signal to a frequency-domain signal, and outputs the signal obtained as a result of the conversion.

The gain adjustment unit 110 includes an amplitude calculation unit 111, a sum calculation unit 112, a bandwidth extraction unit 113, a bandwidth occupation ratio calculation unit 114, a reciprocal calculation unit 115, a multiplier 116, and a gain setting unit 117.

The amplitude calculation unit 111 calculates and outputs respective amplitudes (in decibels) of each of the data pieces included in the received signal within the desired bandwidth. The number of data pieces is equivalent to the number of carriers in one cycle.

The sum calculation unit 112 calculates and outputs a sum of the calculated amplitudes.

The bandwidth extraction unit 113 detects desired signal components within the desired bandwidth, which are signal components having reception levels higher than or equivalent to a predetermined threshold, and transmits the results to the bandwidth occupation ratio calculation unit 114. Here, the predetermined threshold should be at least set to the lower most reception level by which the existence of waves can be detected.

The bandwidth occupation ratio calculation unit 114 calculates and outputs the ratio of the number of the desired signal components having reception levels higher than or equivalent to the threshold extracted by the bandwidth extraction unit 113 to the total number of signal components contained in the desired bandwidth.

The reciprocal calculation unit 115 calculates and outputs a reciprocal of the ratio output from the bandwidth occupation ratio calculation unit 114 indicating the ratio of desired signal components.

The multiplier 116 performs multiplication of the sum output by the sum calculation unit 112 and the reciprocal output by the reciprocal calculation unit 115.

The gain setting unit 117 calculates a gain by dividing a target level L by a value obtained by dividing the value output from the multiplier 116 by the bandwidth W, and sets the gain to the amplifier 101.

<Operations>

Here, description will be made on the procedures involved up to the point where the gain adjustment unit 110 sets the gain. First, the amplitude calculation unit 111, based on the quadrature signal from which adjacent channel signal components have been removed by the FIL 104, calculates and outputs respective amplitudes (in decibels) of each of the data pieces included, the number of data pieces being equivalent to the number of carriers in one cycle. Subsequently, the sum calculation unit 112 calculates and outputs the sum of the amplitudes output from the amplitude calculation unit 111.

Meanwhile, the FFT 105 performs a fast fourier transform on the quadrature signal received from the FIL 104, from which adjacent channel signal components have been removed, to obtain a frequency-domain signal. The output frequency-domain signal is demodulated by the demodulation unit (undepicted) in the subsequent step.

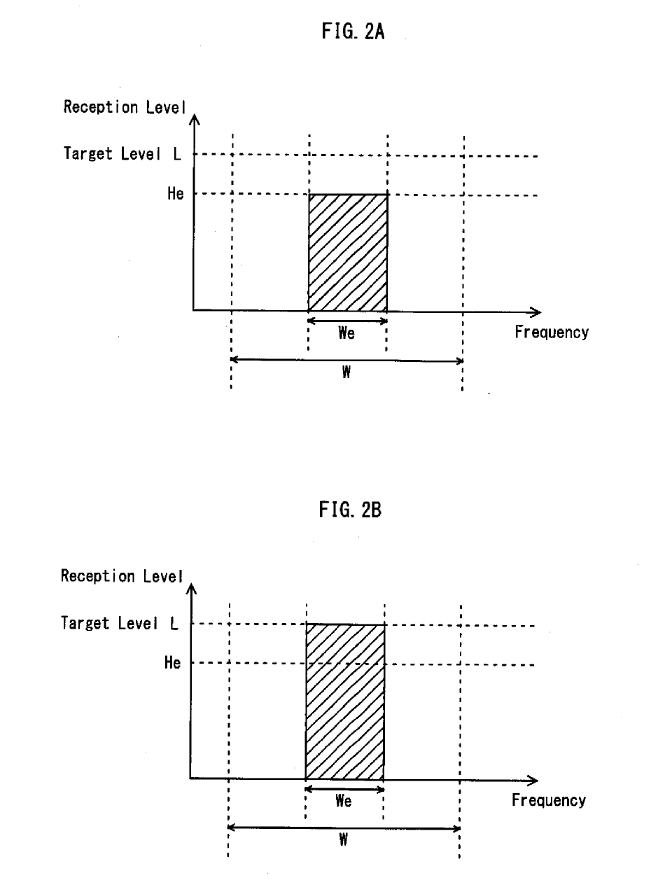

The frequency-domain signal is also output to the bandwidth extraction unit 113. The bandwidth extraction unit 113 detects desired signal components of the frequency-domain signal which have reception levels higher than or equivalent to the predetermined threshold. The bandwidth occupation ratio calculation unit 114 calculates the ratio of the desired signal components to the entirety of signal components contained in the bandwidth W. More specifically, the bandwidth occupation ratio calculation unit 114 calculates how many of the sampling points have reception levels higher than or equivalent to the predetermined threshold. Here, the number of sampling points is equivalent to the number of carriers and the ratio to be obtained in this step is defined by We/W, referring to FIG. 2A.

The reciprocal calculation unit 115 calculates and outputs, to the multiplier 116, a reciprocal (W/We) of the ratio obtained by the bandwidth occupation ratio calculation unit 114.

The multiplier 116 performs multiplication of the sum (We×He) output by the sum calculation unit 112 and the reciprocal output by the reciprocal calculation unit 115, and outputs the value (We×He×W/We=He×W) to the gain setting unit 117.

The gain setting unit 117 calculates a gain (L/He) by dividing a target level L by a value obtained by dividing the value output from the multiplier 116 (He×W) by the bandwidth W, and sets the gain to the amplifier 101.

Having the above structure, the radio base station 100 makes possible the amplification of the reception level of the received signal components within the desired bandwidth to an appropriate target level as depicted in FIG. 2B, even in cases where the received signal is a signal as depicted in FIG. 2A, which does not have a reception level reaching the target level and in which desired signal components do not exist covering the entire range of the reception bandwidth W.

<Consideration>

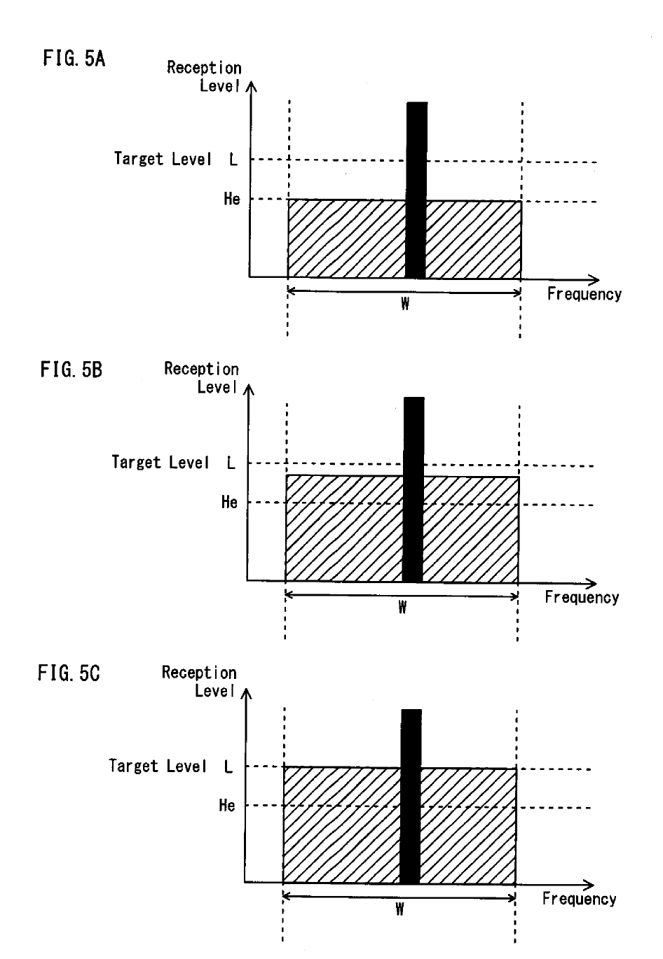

Hereafter, analysis will be made on the accuracy of gain adjustment according to the above embodiment 1 of the present invention, with reference to FIG. 2 and FIG. 5.

Firstly, description will be made on a case where a conventional method of gain setting is applied. Note that the description hereafter is based on a presumption that the interference wave components depicted as the black bar in FIG. 5A do not exist. Under such conditions, the gain value G is set so that the average value, calculated by dividing the sum ΣHe (=He×W) of levels of signal components existing within the desired bandwidth (depicted as the shadowed area in FIG. 5A) by the bandwidth, is equivalent to the target level L. Hence, if the reception level of the received signal components within the desired bandwidth is He, the gain will be calculated by G=(L×W)/(He×W)=L/He. Further, the target level L is obtained by multiplying He by G. Hence, in consequence, the gain G is a value obtained by dividing the target level L by the average reception level of signal components within the reception band.

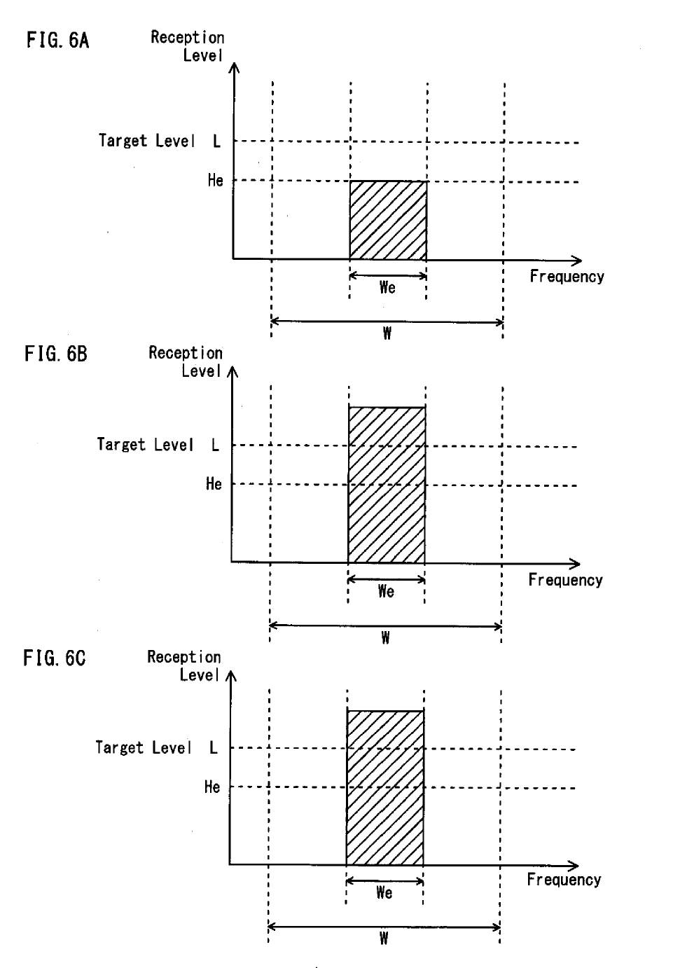

In cases as depicted in FIG. 2A where desired signal components exist covering only a range We of the bandwidth W, the gain is set to a value as shown below, the gain adjustment of the conventional technology or Patent Literature 1 being applied. The gain Gf in such cases is calculated using the equation Gf=L/{(He×We)/W}=(L×W)/(He×We). Here, if the reception level He of the received signal components within the desired bandwidth is multiplied by the gain Gf, the amplified reception level Hf is calculated by Hf=He×Gf=L×W/We. Since We is smaller than W, the equation W/We>1 is fulfilled, and hence Hf will exceed the target level L (refer to FIG. 6B).

Contrastingly, in the present invention, the gain Gg is calculated by multiplying the average reception level by the reciprocal of the bandwidth occupation ratio Rg. Thus, the reception level He of the received signal components within the desired bandwidth is properly converted to L. According to embodiment 1 of the present invention, the gain Gg is calculated by Gg=L/{(He×We)/W}/Rg. Further, since Rg=We/W, Gg=(L×W)/{(He×We)×1/Rg}=(L×W)/{(He×We)×W/We}=(L×W)/(He×W)=L/He. When multiplying the gain Gg by the reception level He of the received signal components within the desired bandwidth, the amplified reception level Hg is calculated as Hg=He×Gg=He×L/He=L. The result of the equation indicates that an amplified reception level Hg of the received signal components within the desired bandwidth is properly converted to the target level L (refer to FIG. 2B).

As could be seen from the above description, the ratio of the number of the desired signal components, or the number of sampling points in which signals are actually found, to the total number of signal components or sampling points contained in the desired bandwidth of the received signal is considered in the calculation of gain in the present invention. Hence, the reception level after being multiplied by the gain does not exceed the target level.

### Embodiment 2

In the above Embodiment 1 pertaining to the present invention, description was made upon the presumption that interference wave components do not exist. However, in practice, the possibility of interference wave components being picked up by the received signal cannot be completely ruled out. Therefore, the present embodiment demonstrates that gain can be appropriately calculated, even in cases where interference wave components do exist.

<Structure>

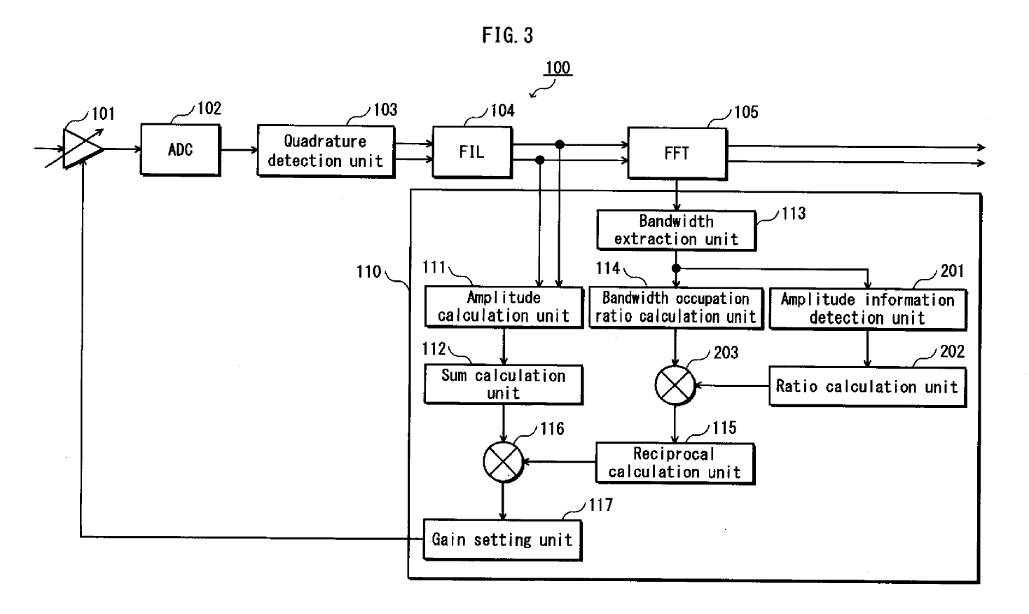

FIG. 3 is a block diagram showing a functional structure of one part of a receiver included in the radio base station 200 according to Embodiment 2 of the present invention.

As is depicted in FIG. 3, the radio base station 200 includes the amplifier 101, the ADC 102, the quadrature detection unit 103, the FIL 104, the FFT 105, and a gain adjustment unit 210. For functional units having the same functions as in Embodiment 1, the same names and reference signs are applied thereto and description of such units is partially omitted as being similar to that in Embodiment 1. Note that in the present embodiment, gain set to the amplifier 101 is determined by the gain setting unit 117 of the gain adjustment unit 210.

Further, the gain adjustment unit 210 is the aspect distinguishing Embodiment 2 from Embodiment 1.

As is depicted in FIG. 3, the gain adjustment unit 210 includes the amplitude calculation unit 111, the sum calculation unit 112, the bandwidth extraction unit 113, the bandwidth occupation ratio calculation unit 114, the reciprocal calculation unit 115, the multiplier 116, the gain setting unit 117, an amplitude information detection unit 201, a ratio calculation unit 202, and a multiplier 203.

The amplitude calculation unit 111 calculates and outputs amplitudes of signal components contained within the desired bandwidth of the received signal.

The sum calculation unit 112 calculates and outputs a sum of the calculated amplitudes.

The bandwidth extraction unit 113 detects desired signal components having reception levels higher than or equivalent to a predetermined threshold, and transmits the results to the bandwidth occupation ratio calculation unit 114.

The bandwidth occupation ratio calculation unit 114 calculates and outputs the ratio of the number of desired signal components extracted by the bandwidth extraction unit 113, having reception levels higher than or equivalent to the threshold, to the total number of signal components contained in the desired bandwidth.

The amplitude information detection unit 201 detects sampling points, having amplitudes lower than an average value of amplitudes of signal components within the desired bandwidth as well as having reception levels higher than or equivalent to the above-described threshold, from among a number of sampling points equivalent to the number of carriers.

The ratio calculation unit 202 calculates and outputs the actual ratio of desired signal components in the received signal. More precisely, the ratio calculation unit calculates and outputs the ratio of the number of the sampling points detected by the amplitude information detection unit 201 to the desired sampling points having a signal value higher than or equivalent to the predetermined threshold, the number of sampling points being equivalent to the number of carriers.

The multiplier 203 multiplies the ratio calculated by the bandwidth occupation ratio calculation unit 114 by the ratio calculated by the ratio calculation unit 202 and outputs the result.

The reciprocal calculation unit 115 calculates and outputs a reciprocal of the value obtained from the multiplier 203.

The multiplier 116 performs multiplication of the sum output by the sum calculation unit 112 and the reciprocal output by the reciprocal calculation unit 115.

The gain setting unit 117 calculates a gain by dividing a target level L by a value obtained by dividing the value output from the multiplier 116 by the bandwidth W, and sets the gain to the amplifier 101.

<Operations>

Here, description will be made on the procedures involved up to the point where the gain adjustment unit 210 sets the gain. First, the amplitude calculation unit 111, based on the quadrature signal from which adjacent channel signal components have been removed by the FIL 104, calculates and outputs respective amplitudes (in decibels) of each of the data pieces included, the number of data pieces being equivalent to the number of carriers in one cycle. Following this, the sum calculation unit 112 calculates and outputs the sum of the amplitudes output from the amplitude calculation unit 111.

Meanwhile, the FFT 105 performs a fast fourier transform on the quadrature signal received from the FIL 104, from which adjacent channel signal components have been removed, to obtain a frequency-domain signal. The output frequency-domain signal is demodulated by the demodulation unit (undepicted) in the subsequent step.

The frequency-domain signal is also output to the bandwidth extraction unit 113. The bandwidth extraction unit 113 detects desired signal components of the frequency-domain signal which have reception levels higher than or equivalent to the predetermined threshold.

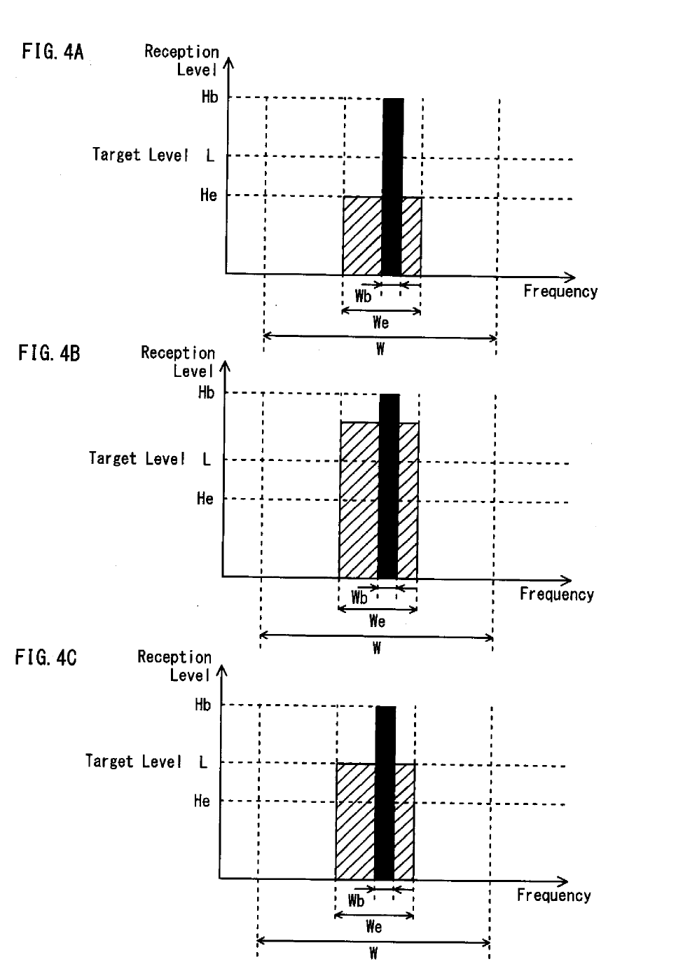

The bandwidth occupation ratio calculation unit 114 calculates the ratio of the number of the desired signal components to the total number of signal components contained in the bandwidth W. More specifically, the bandwidth occupation ratio calculation unit 114 calculates how many of the sampling points have reception levels higher than or equivalent to the predetermined threshold. Here, the number of sampling points is equivalent to the number of carriers, and the ratio to be obtained in this step is defined by We/W, referring to FIG. 4A.

Meanwhile, the amplitude information detection unit 201 detects sampling points having amplitudes lower than the average value of amplitudes, from among sampling points having amplitudes higher than the predetermined threshold. Subsequently, the ratio calculation unit 202 detects the actual ratio of the desired signal components contained in the desired bandwidth. More precisely, the ratio calculation unit calculates and outputs the ratio of the number of the sampling points detected by the amplitude information detection unit 201 to the number of the desired sampling points having a reception level higher than or equivalent to the predetermined threshold, the number of sampling points being equivalent to the number of carriers. The ratio calculated by the ratio calculation unit is defined as {(We−Wb)×He+Wb×Hb}/(We×He).

The multiplier 203 multiplies the ratio calculated by the bandwidth occupation ratio calculation unit 114 by the ratio calculated by the ratio calculation unit 202 and outputs the result ({(We−Wb)×He+Wb×Hb}/(W×He)).

The reciprocal calculation unit 115 calculates a reciprocal of the value output from the multiplier 203, and outputs the calculated reciprocal number ((W×He)/{(We−Wb)×He+Wb×Hb}) to the multiplier 116.

The multiplier 116 performs multiplication of the sum ((We−Wb)×He+Wb×Hb) output by the sum calculation unit 112 and the reciprocal output by the reciprocal calculation unit 115, and outputs the obtained value (W×He) to the gain setting unit 117.

The gain setting unit 117 calculates a value (L/He) by dividing a target level L by a value (He) obtained by dividing the value (W×He) output from the multiplier 116 by the bandwidth W, and outputs the value as the gain to the amplifier 101.

Having the above structure the radio base station 100 makes possible the amplification of the reception level of the received signal components within the desired bandwidth to the appropriate target level as depicted in FIG. 4C, even in cases where the received signal is a signal as depicted in FIG. 4A, which does not have a reception level reaching the target level and in which desired signal components do not exist covering the entire range of the reception bandwidth W.

<Consideration>

Hereafter, analysis will be made on the accuracy of gain adjustment according to the above embodiment 2 of the present invention, with reference to accompanying FIG. 4.

Firstly, a gain Gh fulfills Gh=(L×W)/{(We−Wb)×He+Wb×Hb} according to the gain adjustment of the conventional technology or Patent Literature 1. Further, if the reception level He of the received signal components within the desired bandwidth is multiplied by the gain Gh, the amplified reception level Hf is calculated by Hf=He×Gh. Here, if the value Hb is given a considerably large value in the above calculation, the gain will be set to an appropriate level. However, since it is impossible to carry out communication in an environment in which interference wave components with such high reception levels are picked up in the first place, the above presumption is unrealistic.

If the above described situation (when the value Hb is given a considerably large value, the gain is set to an appropriate level) is ruled out, then the target level will be exceeded when the gain Gh as obtained from the above calculation is applied to the reception level of the received signal components within the desired bandwidth, as depicted in FIG. 4B.

Contrastingly, in the present invention, the bandwidth occupation ratio calculation unit 114 calculates the ratio R_{IA}=We/W, which indicates the ratio of the number of the desired signal components to the total number of signal components contained in the desired bandwidth, while the ratio calculation unit calculates the ratio R_{IB}={(We−Wb)×He+Wb×Hb}/(We×He), which indicates the ratio of the desired signal components (interference wave components excluded therefrom) to a signal including both the desired wave components and the interference wave components. Further, the multiplier 203 performs a multiplication of the two ratios R_{IA} and R_{IB} to obtain R_{I}={(We−Wb)×He+Wb×Hb}/(W×He). Finally, the gain Gi of the present embodiment is obtained by dividing the target level L by a value obtained by multiplying a reciprocal of R_{I} by the average value of the reception levels of the received signal components within the desired bandwidth.

This calculation produces L/He as the value of Gi, as shown below. Gi=L/[{(We−Wb)×He+Wb×Hb}×(W×He)/W]/R_{I}=(L×W)/{(We−Wb)×He+Wb×Hb}×(W×He)/{(We−Wb)×He+Wb×Hb}=L/He.

Thus, the amplified reception level Hj, obtained by multiplying the reception level He of the received signal components within the desired bandwidth by the gain Gi, fulfills Hj=He×L/He=L, from which it is confirmed that the target level is appropriately calculated in the gain adjustment according to embodiment 2.

### MODIFICATIONS

In the above embodiments, description has been made of applications of the present invention, but however, the present invention is not limited to this. Hereinafter, description will be made on various modifications which are considered as being included within the technical idea of the present invention.
(1) In the above embodiments, the bandwidth W is set to 10 MHz and the number of sampling points was set to 1024, but this limitation is for the mere sake of examples. These numbers may be altered, according to the specifications of the communication method applied, and for example, the bandwidth may be set to 20 MHz and the number of sampling points may be set to 2048.
(2) In the above embodiments, the amplitude calculation unit 112 is configured to calculate amplitudes of signals before being performed FFT thereon, but the present invention is not limited to this. That is, the amplitude calculation unit 112 may be configured to calculate amplitudes of signals after being performed FFT thereon.
(3) In Embodiment 2, the amplitude information detection unit 201 is configured to detect signal components having reception levels lower than the average value of the reception levels of the received signal components within the desired bandwidth, so as to calculate the ratio of the desired signal components under a condition where interference wave components are picked up by the received signal. However, the present invention is not limited to this, and the amplitude information detection unit 201 may be configured to detect signal components having reception levels lower than a specific threshold set beforehand. Note that, in such a case, the specific threshold needs to be provided a higher value than the reception level (i.e. He) of the received signal components within the desired bandwidth in Embodiment 2. Therefore, the specific threshold is to be provided an appropriate value, by detecting and analyzing the reception level of signals received by the radio base station pertaining to the present invention.
(4) It may be conceived to distribute, by recording onto recording media or via various communication paths, a control program consisted of a program code for causing the processor included in the radio base station or various circuits connected to the processor to perform the gain control operations as described in the above embodiments. Such recording media may include: IC cards, hard discs, optical discs, flexible discs, ROMs and the like. Further, the distributed control program may be made available for use by being stored on such devices as a processor-readable memory, and so on. The various functions as described in the above embodiments may be realized by the control program being executed by the processor.

### INDUSTRIAL APPLICABILITY

The radio base station of the present invention realizes appropriate gain setting, even in cases where a received signal is a signal in which desired signal components do not exist covering the entire range of the reception band.

### REFERENCE SIGNS LIST

100 radio base station
101 amplifier
102 ADC
103 quadrature detection unit
104 FIL
105 FFT
110 gain adjustment unit
111 amplitude calculation unit
112 sum calculation unit
113 bandwidth extraction unit
114 bandwidth occupation ratio calculation unit
115 reciprocal calculation unit
116 multiplier
117 gain setting unit

1. A radio base station for adjusting a reception level of a received signal to a desired level, the radio base station comprising:
a reception unit operable to receive a signal of a desired frequency band;
a first detection unit operable to calculate a ratio of a plurality of first signal components to an entirety of signal components contained in the desired frequency band of the received signal, the first signal components each having a reception level higher than or equal to a predetermined threshold; and
a gain calculation unit operable to calculate a gain used to amplify the reception level of the received signal according to the ratio.

2. The radio base station of claim 1 further comprising:
a second detection unit operable to calculate a ratio of a plurality of second signal components to the first signal components, the second signal components being included within the first signal components and each having a reception level lower than a second predetermined threshold, wherein
the gain calculation unit calculates the gain according to the ratio calculated by the second detection unit in addition to the ratio calculated by the first detection unit.

3. The radio base station of claim 1, wherein
the gain calculation unit calculates the gain by dividing the desired level by a product obtained by multiplication of an average of levels of the signal components within the desired frequency band and a reciprocal of the ratio calculated by the first detection unit.

4. The radio base station of claim 2, wherein
the gain calculation unit calculates the gain by dividing the desired level by a product obtained by multiplication of a reciprocal of a second product and an average value of levels of the signal components within the desired frequency band, the second product being obtained by multiplication of the ratio calculated by the first detection unit and the ratio calculated by the second detection unit.

5. The radio base station of claim 1, further comprising:
a gain adjustment unit operable to adjust the reception level by amplifying the reception level of the received signal with the gain calculated by the gain calculation unit by using feedback control; and
a demodulation unit operable to demodulate the received signal having the reception level adjusted by the gain adjustment unit.
